(19) United States
(12) Patent Application Publication
(10) Pub. No.: US 2006/0166629 A1
(43) Pub. Date: Jul. 27, 2006

(54) Method and apparatus for providing EMC Class-B compliant RF transmitter for data monitoring an detection systems

(75) Inventor: Christopher V. Reggiardo, Castro Valley, CA (US)

Correspondence Address: JACKSON & CO., LLP, 6114 LA SALLE AVENUE, SUITE 507, OAKLAND, CA, 94611-2802, US

(73) Assignee: TheraSense, Inc., Alameda, CA (US)

(21) Appl. No.: 11/041,566

(22) Filed: Jan. 24, 2005

(51) Int. Cl. H04B 1/04; H01Q 11/12

(52) U.S. Cl. 455/120

(57) ABSTRACT

Method and apparatus for providing EMC Class-B compliant RF transmission for a data monitoring and detection system having a sensor for detecting one or more glucose levels, a transmitter configured to transmit a respective signal corresponding to each of the detected glucose levels using a data transmission protocol including wireless data transmission protocols, to a receiver which is configured to receive the transmitted signals corresponding to the detected glucose levels is provided. When placed in an EMC Class-B compliant mode the monitoring and detection system along with any associated patient treatment units would be allowed to operate in hospital environments and on commercial aircraft during flight.

### BACKGROUND

The present invention relates to data monitoring and detection systems. More specifically, the present invention relates to eletrometry detection systems and/or electro-physiology monitoring systems as used in radio frequency (RF) communication systems for data communication between portable electronic devices such as in continuous glucose monitoring systems.

Continuous glucose monitoring systems generally include a small, lightweight battery powered and microprocessor controlled system which is configured to detect signals proportional to the corresponding measured glucose levels using an electrometer, and RF signals to transmit the collected data. One aspect of such continuous glucose monitoring systems include a sensor configuration which is, for example, mounted on the skin of a subject whose glucose level is to be monitored. The data from the sensor is collected and transmitted at a given RF frequency and power level so as to be compliant with the regulations of the country in which the device is operated while having an RF range of at least a few meters.

There are certain areas where RF transmitting devices, such as cellphones, are prohibited; yet, other electronic devices that meet EMC Class-B radiated emissions standards are permitted to operate. One such environment is during flight on commercial aircraft. Another environment is in a hospital. If the transmitted RF power were reduced to a level that still allowed an RF range of at least one meter while complying with EMC Class-B radiated emissions standards, then the monitoring and detection devices could safely operate in hospitals and on commercial aircraft during flight without stringent reviews by each air carrier or hospital.

In view of the foregoing, it would be desirable to have an RF configuration in data monitoring and detection systems such as in continuous glucose monitoring systems such that the transmitted RF power may be reduced to levels that are compliant with EMC Class-B regulatory limits. This will become increasingly important as these data monitoring and detection systems are coupled to treatment systems such as insulin administration units for administering an insulin dose based on the detected glucose level.

### SUMMARY OF THE INVENTION

In accordance with one embodiment of the present invention, there is provided an RF transmitter which may be configured to operate with variable power output levels. The RF power may be changed through the use of a variable output RF power amplifier. More specifically, in one embodiment, the RF output power of the transmitter may be set to one of several predefined levels for normal operation and Class-B EMC compliant operation.

Moreover, a tuning circuitry associated with the antenna may be switched from a mode for tuning used for normal operation to one for Class-B EMC compliant operation. In turn, the RF output power of the transmitter would change with each of the antenna tuning circuitry configurations. In a further embodiment, the antenna configuration may be switched from a mode used for normal operation to one for Class-B EMC compliant operation. Again, the RF output power of the transmitter would change with each of the antenna configurations.

Additionally, in an alternate embodiment of the present invention, a combination of power amplifier output levels, antenna tuning circuitry configurations, and antenna configurations may be employed for normal operation and for Class-B EMC compliant operation. Also, the transmitter may be configured to transmit the signal wirelessly using proprietary transmission protocols, Bluetooth, Zigbee, and 802.11x transmission protocols.

### BRIEF DESCRIPTION OF THE DRAWINGS

FIG. 1 illustrates a block diagram of a data monitoring and detection system such as a continuous glucose monitoring system for practicing one embodiment of the present invention;

FIG. 2 is a block diagram of the transmitter unit of the data monitoring and detection system shown in FIG. 1 in accordance with one embodiment of the present invention;

FIG. 3 is a block diagram of the RF transmitter/transceiver section of the transmitter unit shown in FIG. 2 in accordance with one embodiment of the present invention; and

FIG. 4 is a block diagram of the RF transmitter/transceiver section of the transmitter unit shown in FIG. 2 in accordance with another embodiment of the present invention.

### DETAILED DESCRIPTION

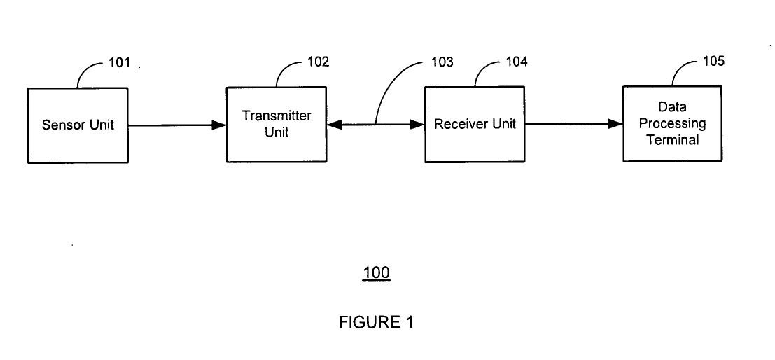

FIG. 1 illustrates a data monitoring and detection system 100 such as, for example, a continuous glucose monitoring system in accordance with one embodiment of the present invention. In such an embodiment, the continuous glucose monitoring system 100 includes a sensor 101, a transmitter 102 coupled to the sensor 101, and a receiver 104 which is configured to communicate with the transmitter 102 via a communication link 103. The receiver 104 may be further configured to transmit data to a data processing terminal 105 for evaluating the data received by the receiver 104. Only one sensor 101, transmitter 102, communication link 103, receiver 104, and data processing terminal 105 are shown in the embodiment of the continuous glucose monitoring system 100 illustrated in FIG. 1. However, it will be appreciated by one of ordinary skill in the art that the continuous glucose monitoring system 100 may include one or more sensor 101, transmitter 102, communication link 103, receiver 104, and data processing terminal 105, where each receiver 104 is uniquely synchronized with a respective transmitter 102.

In one embodiment of the present invention, the sensor 101 is physically positioned on the body of a user whose glucose level is being monitored. The sensor 101 is configured to continuously sample the glucose level of the user and convert the sampled glucose level into a corresponding data signal for transmission by the transmitter 102. In one embodiment, the transmitter 102 is mounted on the sensor 101 so that both devices are positioned on the user's body. The transmitter 102 performs data processing such as filtering and encoding on data signals, each of which corresponds to a sampled glucose level of the user, for transmission to the receiver 104 via the communication link 103.

In one embodiment, the continuous glucose monitoring system 100 is configured as a one-way RF communication path from the transmitter 102 to the receiver 104. In such embodiment, the transmitter 102 transmits the sampled data signals received from the sensor 101 without acknowledgement from the receiver 104 that the transmitted sampled data signals have been received. For example, the transmitter 102 may be configured to transmit the encoded sampled data signals at a fixed rate (e.g., at one minute intervals) after the completion of the initial power on procedure. Likewise, the receiver 104 may be configured to detect such transmitted encoded sampled data signals at predetermined time intervals.

Additionally, in one aspect, the receiver 104 may include two sections. The first section is an analog interface section that is configured to communicate with the transmitter 102 via the communication link 103. In one embodiment, the analog interface section may include an RF receiver and an antenna for receiving and amplifying the data signals from the transmitter 102, which are thereafter, demodulated with a local oscillator and filtered through a band-pass filter. The second section of the receiver 104 is a data processing section which is configured to process the data signals received from the transmitter 102 such as by performing data decoding, error detection and correction, data clock generation, and data bit recovery.

In operation, upon completing the power-on procedure, the receiver 104 is configured to detect the presence of the transmitter 102 within its range based on, for example, the strength of the detected data signals received from the transmitter 102 or a predetermined transmitter identification information. Upon successful synchronization with the corresponding transmitter 102, the receiver 104 is configured to begin receiving from the transmitter 102 data signals corresponding to the user's detected glucose level. More specifically, the receiver 104 in one embodiment may be configured to perform synchronized time hopping with the corresponding synchronized transmitter 102 via the communication link 103 to obtain the user's detected glucose level.

Referring again to FIG. 1, the data processing terminal 105 may include a personal computer, a portable computer such as a laptop or a handheld device (e.g., personal digital assistants (PDAs)), and the like, each of which may be configured for data communication with the receiver via a wired or a wireless connection. Additionally, the data processing terminal 105 may further be connected to a data network (not shown) for storing, retrieving and updating data corresponding to the detected glucose level of the user.

Furthermore, within the scope of the present invention, the data processing terminal 105 may be operatively coupled to a medication delivery unit such as an insulin pump. Additionally, the transmitter 102 may be configured for bi-directional communication over the communication link 103 with the receiver 104 as discussed in further detail below.

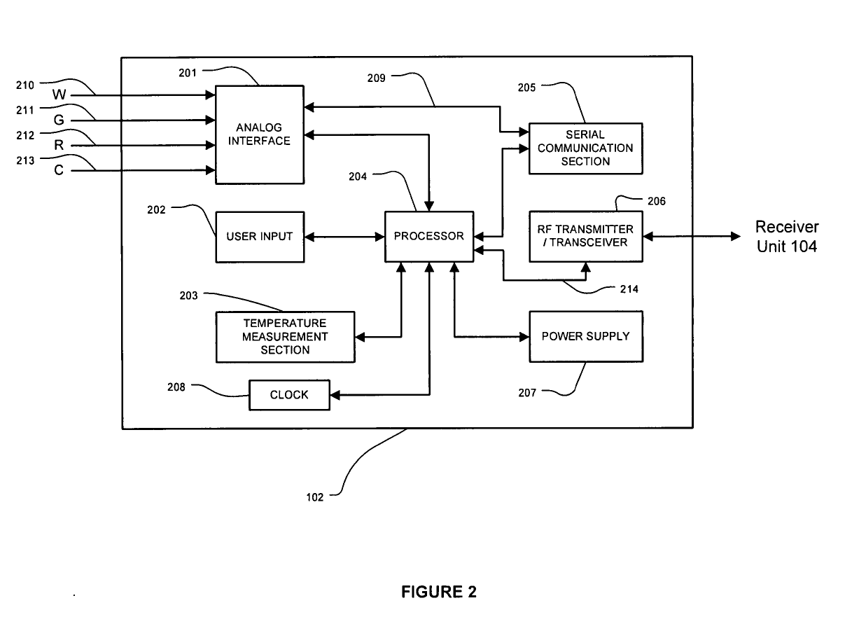

FIG. 2 is a block diagram of the transmitter of the data monitoring and detection system shown in FIG. 1 in accordance with one embodiment of the present invention. Referring to the Figure, the transmitter 102 in one embodiment includes an analog interface 201 configured to communicate with the sensor 101 (FIG. 1), a user input 202, and a temperature measurement section 203, each of which is operatively coupled to a transmitter processor 204 such as a central processing unit (CPU).

As can be seen from FIG. 2, a sensor in the sensor unit 101 may include four contacts, three of which are electrodes—work electrode (W) 210, guard contact (G) 211, reference electrode (R) 212, and counter electrode (C) 213, each operatively coupled to the analog interface 201 of the transmitter 102 for connection to the sensor unit 101 (FIG. 1). In one embodiment, each of the work electrode (W) 210, guard contact (G) 211, reference electrode (R) 212, and counter electrode (C) 213 may be made using a conductive material that is either printed or etched, for example, such as carbon which may be printed, or metal foil (e.g., gold) which may be etched.

Further shown in FIG. 2 is a transmitter serial communication section 205 which is operatively coupled to the transmitter processor 204 and an RF transmitter 206 which is also operatively coupled to the transmitter processor 204 through a control and data link 214. Moreover, a power supply 207 such as a battery is also provided in the transmitter 102 to provide the necessary power for the transmitter 102. Additionally, as can be seen from the Figure, clock 208 is provided to, among others, supply real time information to the transmitter processor 204.

In one embodiment, a unidirectional input path is established from the sensor 101 (FIG. 1) and/or manufacturing and testing equipment to the analog interface 201 of the transmitter 102, while a unidirectional output is established from the output of the RF transmitter 206 of the transmitter 102 for transmission to the receiver 104. In this manner, a data path is shown in FIG. 2 between the aforementioned unidirectional input and output via a dedicated link 209 from the analog interface 201 to serial communication section 205, thereafter to the processor 204, and then to the RF transmitter 206. In this manner, in one embodiment, via the data path described above, the transmitter 102 is configured to transmit to the receiver 104 (FIG. 1), via the communication link 103 (FIG. 1), processed and encoded data signals received from the sensor 101 (FIG. 1). Additionally, the unidirectional communication data path between the analog interface 201 and the RF transmitter 206 discussed above allows for the configuration of the transmitter 102 for operation upon completion of the manufacturing process as well as for direct communication for diagnostic and testing purposes.

As discussed above, the transmitter processor 204 is configured to transmit control signals to the various sections of the transmitter 102 during the operation of the transmitter 102. In one embodiment, the transmitter processor 204 also includes a memory (not shown) for storing data such as the identification information for the transmitter 102, as well as the data signals received from the sensor 101. The stored information may be retrieved and processed for transmission to the receiver 104 under the control of the transmitter processor 204. Furthermore, the power supply 207 may include a commercially available battery.

The transmitter 102 is also configured such that the power supply section 207 is capable of providing power to the transmitter for a minimum of three months of continuous operation after having been stored for approximately 18 months in a low-power (non-operating) mode. In one embodiment, this may be achieved by the transmitter processor 204 operating in low power modes in the non-operating state, for example, drawing no more than approximately 1 μA of current. Indeed, in one embodiment, the final step during the manufacturing process of the transmitter 102 may place the transmitter 102 in the lower power, non-operating state (i.e., post-manufacture sleep mode). In this manner, the shelf life of the transmitter 102 may be significantly improved.

Referring yet again to FIG. 2, the temperature measurement section 203 of the transmitter 102 is configured to monitor the temperature of the skin near the sensor insertion site. The temperature reading is used to adjust the glucose readings obtained from the analog interface 201. More specifically, in one embodiment, the temperature reading of the skin monitored by the temperature measurement section 203 is used to compensate for, among others, errors and deviations in the measured glucose level due to skin temperature variation.

In one embodiment, the RF transmitter 206 of the transmitter 102 may be configured for operation in the frequency band of 315 MHz to 322 MHz, for example, in the United States. Further, in one embodiment, the RF transmitter 206 is configured to modulate the carrier frequency by performing Frequency Shift Keying and Manchester encoding. In one embodiment, the data transmission rate is 19,200 symbols per second, with a minimum transmission range for communication with the receiver 104.

Additional detailed description of the continuous glucose monitoring system, its various components including the functional descriptions of the transmitter are provided in U.S. Pat. No. 6,175,752 issued on Jan. 16, 2001 entitled “Analyte Monitoring Device and Methods of Use”, and in application Ser. No. 10/745,878 filed Dec. 26, 2003 entitled “Continuous Glucose Monitoring System and Methods of Use”, each assigned to the Assignee of the present application, and the disclosures of each of which are incorporated herein by reference for all purposes.

Referring back to FIGS. 1-2, in one embodiment of the present invention, the transmitter unit 102 may be configured to operate in one of three primary states—OFF, ON, and CLASS-B. Each of the three operating states of the transmitter unit 102 of the data monitoring and detection system 100 is described below.

In the OFF state, the transmitter unit 102 is configured to not transmit the periodic RF signal for reception by the receiver unit 104 via the communication link 103. Indeed, in the OFF state, the RF transmitter 206 is configured to maintain an inactive operating state. This state may be used any time that data communications are not allowed, such as during takeoff and landing on commercial aircraft, or when communications are not desired, such as during medical procedures when the user is unable to respond to messages from the receiver unit 104 and other monitoring is being used during the procedure.

More specifically, in the OFF state, the transmitter unit 102 may be configured so that the periodic data that is transmitted via the RF communications link 103 may be stored in the processor 204 until the transmitter unit 102 operating state is modified to a state that allows for periodic data transmission such as the ON or CLASS-B states. For example, 15 minutes of data may be stored by the processor 204 in the transmitter unit 102 until the transmitter unit 102 switches from the OFF state to either the ON state or the CLASS-B operating state.

The ON state of the transmitter unit 102 may be used in normal operation where the transmitter unit 102 is configured to periodically communicate, for example, once per minute, with the receiver unit 104 via the RF communications link 103 at distances of 3 meters to 10 meters or more. In the ON state of the transmitter unit 102, the RF signal strength of the RF communications link 103 may be restricted to values permissible for a given RF frequency in a given region. For example, in the United States of America, the RF communications frequency of 315 MHz is allowed for unlicensed periodic communication with signal strengths of up to 68 dBμV/m as measured at 3 m per FCC CFR 47 Part 15.231.e (due to a −28 dB free-space loss this is equivalent to 40 dBμV/m as measured at 10 m).

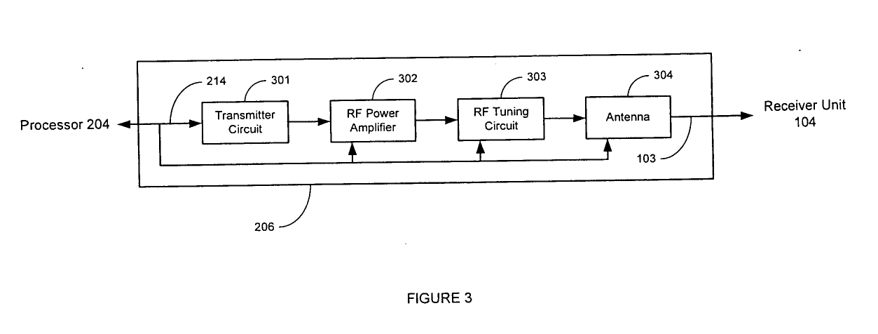

More specifically, referring back to FIG. 2, in one embodiment of the present invention, a set of digital communications and control signals 214 may be periodically used to activate the RF transmitter 206 and to transmit an RF signal including data to the receiver unit 104 via the RF communications link 103 at a signal strength of approximately 37 dBμV/m as measured at 10 m. This signal strength is designed to be about 3 dBμV/m below the regulatory limit to provide for unit to unit variation without exceeding the regulatory limit. The digital communication and control signals 214 may be converted to analog signals at the same frequency and encoding as the RF communications link 103 by the transmitter circuit 301 discussed in further detail below in conjunction with FIG. 3.

The CLASS-B state of the transmitter unit 102 is the state used during restricted operation where the transmitter unit 102 is configured to communicate periodically, for example once per minute, with the receiver unit 104 via the RF communications link 103 at distances of 1 meters to 2 meters or more using a reduced RF signal strength. In the CLASS-B state, the RF signal strength of the RF communications link 103 may be restricted to a value below the permissible limit for an electronic device that complies with Class-B radiated emissions standards such as IEC 60601-1-2, EN55022 (EN55011), CISPR 22 (CISPR 11) Group 1 and FCC Part 15. Indeed, the CLASS-B operating state of the transmitter unit 102 may be used in circumstances where general RF communications are not allowed, but the use of Class-B compliant electronic devices is allowed. One example of such circumstances is during flight on commercial aircraft or when one is in a restricted area of a hospital where cellphones and other general RF devices are prohibited. Indeed, if a user is taking a flight on a commercial aircraft, especially a long flight such as across country or overseas, or if the user worked in a restricted area of a hospital, the CLASS-B operating state of the transmitter unit 102 may still function in the data monitoring and detection system 100 without potentially interfering with the operation of the aircraft or hospital systems.

For example, the RF frequency of 315 MHz is restricted to 37 dBμV/m of radiated emissions as measured at 10 m. Specifically, in one embodiment, a set of digital communications and control signals 214 are periodically used to activate the RF transmitter 206 and transmit an RF signal containing data to the receiver unit 104 via the RF communications link 103 at a signal strength of about 34 dB μV/m as measured at 10 m. It can be seen that this signal strength is designed to be about 3 dB uV/m below the Class-B regulatory limit to provide for unit to unit variation without exceeding the Class-B regulatory limit. The digital communication and control signals 214 are then converted to analog signals at the same frequency and encoding as the RF communications link 103 by the transmitter circuit 301.

Without the CLASS-B state of operation, the transmitter unit 102 would have to remain in the OFF state, and the user would not receive any detection or monitoring data, thus rendering the transmitter unit 102 functionally in non-operating state. Although the example shown only has a 3 dB difference between the ON state and the CLASS-B state, other frequencies and other regions have differing ON state limits. For example, in Europe the frequency 433 MHz, which is regulated in a similar fashion to 315 MHz as used in the United States of America, is allowed to have an ON state output that is over 20 dB higher than the Class-B regulatory limit.

The operation of the three states of the transmitter unit 102 is described below in the following example. When a user takes a commercial air flight she may have the transmitter unit 102 in the ON state while boarding. When the aircraft cabin door is closed and the use of all electronic devices is prohibited, the user must set the transmitter unit 102 to the OFF state. Once the aircraft is in flight and the use of electronic devices that are Class-B EMC compliant is permitted, the user may set the transmitter unit 102 to the CLASS-B state. Conversely, when the aircraft is preparing for landing and the use of all electronic devices are once again prohibited, the user must set the transmitter unit 102 to the OFF state. Finally once the aircraft has landed and the cabin door is opened, or the use of cellphones is permitted while taxiing, the user may set the transmitter unit 102 to the ON state.

Similarly, another example of the functional operation of the three states for the transmitter unit 102 is in a hospital environment where RF transmitters such as cell phones are prohibited but the use of electronic devices that are Class-B EMC compliant is permitted. For example, when the user of the transmitter unit 102 working at a hospital arrives at work, she may set the transmitter unit 102 from the ON state to the CLASS-B state for the duration of the work day so that the transmitter unit 102 is operational and yet not interfere with any sensitive hospital equipment. Once work is over and when the user leaves the hospital, she may switch the transmitter unit 102 from the CLASS-B state to the ON state to benefit from the full functional operating state of the transmitter unit 102.

Within the scope of the present invention, a variety of approaches may be used to change the transmitter unit 102 from one of the OFF, ON, and CLASS-B states to another of the OFF, ON, and CLASS-B states. For example, if a push-button switch were employed for the user input 202, then a series of button presses known as “double-click” and “triple-click” sequences may be used to switch the transmitter unit 102 from one state to another.

FIG. 3 is a block diagram of the RF transmitter/transceiver section of the transmitter unit shown in FIG. 2 in accordance with one embodiment of the present invention. More specifically, in accordance with embodiment of the present invention, the RF transmitter/transceiver section may be configured to operate in a transmit only mode. Referring to the Figure, the RF transmitter 206 in one embodiment includes a transmitter circuit 301 configured to communicate with the processor 204 through control and data link 214, an RF power amplifier 302, an RF tuning circuit 303, and an antenna 304, the output of which is operatively coupled to the receiver unit 104 (FIG. 1) via the communication link 103.

Referring to FIG. 3, the control and data link 214 may be operatively coupled to and used to control the RF power amplifier 302, RF tuning circuitry 303, and the antenna 304. For example, in one embodiment, the transmitter circuit 301 may be configured to receive digital signals (data and control) from the processor 204 via the data link 214, and in turn, generate an RF signal. The RF signal may be an analog signal modulated at the given RF frequency (e.g. a 315 MHz sine wave) and with sufficient offset or “bias” to prevent signal degradation or “clipping”. However, the RF signal may lack sufficient drive strength for the desired RF transmission (i.e. for example, the signal can not drive an antenna with a 50 Ohm load impedance). The RF signal impedance is typically uncontrolled at this stage so the value of the signal is measured in RMS (Root-Mean-Square) as a potential in volts (V) or millivolts (mV), but it can also be measured using other traditional means such as voltage peak-to-peak. Similarly, the signal may be measured using the decibel scale as volts (dBV) or millivolts (dBmV) for convenience so that a 1.0 Volt peak-to-peak signal may be expressed as 0.35 VRMS, −9 dBV, or 51 dBmV.

The RF power amplifier 302 has a high impedance input (typically 1000 Ohms or higher) and low impedance output capable of driving heavy loads such as 20 Ohms. Thus the RF power amplifier 302 may be configured to condition the RF signal, under digital or analog control from the processor 204 via the control and data link 214, to provide an RF signal with the proper power (i.e. 10 dBm) for a given signal strength, such as 50 Ohms, to allow RF transmission (e.g., a 57 dBmV signal driven into a 50 Ohm load is 10 dBm signal). The RF signal at this stage is usually measured in power using the decibel scale as watts (dB) or milliwatts (dBm) since the signal impedance is controlled (i.e. the RF signal is driven into a 50 Ohm load impedance).

The RF tuning circuit 303, also under digital or analog control from the processor 204 via the data link 214 as needed, may be configured to impedance match the RF signal to the antenna for optimal or desired RF transmission (i.e. a 10 dBm signal into the tuning circuit 303 may be a 9 dBm signal out of the tuning circuit 303). Finally the antenna 304, again under digital or analog control from the processor 204 via the data link 214 as needed, may be configured to convert the RF signal from the RF tuning circuit 303 into a transmitted RF signal or an electromagnetic (EM) wave with the desired properties for RF transmission. For example, a 9 dBm signal into antenna 304 with an efficiency of 67% will generate a 6 dBm EM wave.

In one embodiment, the power output level of an RF system may be adjusted by controlling the RF power amplifier 302. Indeed, in accordance with one embodiment of the present invention, the transmitter unit 102 may be configured to comply with regulatory requirements in various countries of operation without substantially modification of the overall RF system design. Moreover, in this manner, the output power on some systems may be adjusted so that they do not overload a nearby RF receiver. One example of this is for Class-1 Bluetooth where the output power is reduced when the associated receiver indicates very high received signal strength.

Referring again to FIG. 3, the control and data link 214 may also be used to control the RF tuning circuitry 303, and the antenna 304. More specifically, the antenna 304 may be “detuned” by switching in or out portions of the RF tuning circuit 303. The affect of the alternate tuning would be to decrease RF power output so that the RF system complies with EMC Class-B radiated standards. Similarly, a portion of the antenna 304 may be shorted out to achieve two modes of operation, one of which complies with EMC Class-B radiated standards. For example, in an RF system that uses a loop antenna, a MOSFET switch may be used to short across and deactivated a portion of the loop antenna so that a smaller loop area remains active and the RF power is reduced in a predefined manner.

Referring back to FIGS. 2-3, in one example where the transmitter unit 102 is in the ON State, the analog signal output from the transmitter circuit 301 may be at a frequency of 315 MHz with a voltage level of 51 dBmV and signal drive strength only capable of driving high impedance loads such as 1000 Ohms. This signal may be amplified by the RF power amplifier 302 to a power level of 10 dBm (assuming a 50 Ohm load) with the signal drive strength capable of driving heavy loads such as 20 Ohms. Subsequently the RF tuning circuit 303 may condition the signal to a power level of 9 dBm with the signal drive strength tuned to 50 Ohms. The antenna 304, such as for example a 50 Ohm loop antenna with 67% efficiency, would then convert the analog signal to an RF signal 103 with a signal strength of 6 dBm as is suitable for ON State RF transmissions.

In a further example where the transmitter unit 102 is in the CLASS-B State, the variable RF power amplifier 302 may be used to change the RF power output and thus the transmitted signal strength from the transmitter unit 102. The analog signal output from the transmitter circuit 301 may be at a frequency of 315 MHz with a voltage level of 51 dBmV and signal drive strength only capable of driving high impedance loads such as 1000 Ohms. This signal may be amplified by the variable RF power amplifier 302 to a voltage power of 5.5 dBm (assuming a 50 Ohm load) with the signal drive strength capable of driving heavy loads such as 20 Ohms. Subsequently the RF tuning circuit 303 may condition the signal to a power level of 4.5 dBm with the signal drive strength tuned to 50 Ohms. The antenna 304, such as for example a 50 Ohm loop antenna with 67% efficiency, would then convert the analog signal to an RF signal 103 with a signal strength of 3 dBm as is suitable for CLASS-B State RF transmissions.

In yet a further example where the transmitter unit 102 is in the CLASS-B State, the variable antenna 304 may be used to change the RF power output from the transmitter unit 102. In this approach, the analog signal output from the transmitter circuit 301 may be at a frequency of 315 MHz with a voltage level of 51 dBmV and signal drive strength only capable of driving high impedance loads such as 1000 Ohms. This signal may be amplified by the RF power amplifier 302 to a power level of 10 dBm (assuming a 50 Ohm load) with the signal drive strength capable of driving heavy loads such as 20 Ohms. Subsequently the RF tuning circuit 303 may condition the signal to a power level of 9 dBm with the signal drive strength tuned to 50 Ohms. The antenna 304, such as for example a 50 Ohm loop antenna with either 67% or 33% efficiency set to 33%, would then convert the analog signal to an RF signal 103 with a signal strength of 3 dBm as is suitable for CLASS-B State RF transmissions.

In yet another example where the transmitter unit 102 is in the CLASS-B State, the variable RF tuning circuit 303 may be used to change the RF power output from the transmitter unit 102 which may also provide a comparatively low system cost. More specifically, the analog signal output from the transmitter circuit 301 may be at a frequency of 315 MHz with a voltage level of 51 dBmV and signal drive strength only capable of driving high impedance loads such as 1000 Ohms. This signal may be amplified by the variable RF power amplifier 302 to a power level of 10 dBm (assuming a 50 Ohm load) with the signal drive strength capable of driving heavy loads such as 20 Ohms. Subsequently the RF tuning circuit 303 may condition the signal to a power level of 4.5 dBm with the signal drive strength tuned to 50 Ohms. The antenna 304, such as for example a 50 Ohm loop antenna with 67% efficiency, would then convert the analog signal to an RF signal 103 with a signal strength of 3 dBm as is suitable for CLASS-B State RF transmissions.

Finally, a combination of the variable RF power amplifier 302, the variable antenna 304 and the variable RF tuning circuit 303 may be used to change the RF power output from the transmitter unit 102 for CLASS-B State operation. The RF power may not only be changed to provide for the above OFF, ON, and CLASS-B states, but also, additional states may be established to account for other operating conditions and regulatory restrictions. For example, additional states could be established for operation in various countries where the maximum permissible ON state RF transmission power has different regulatory limits without requiring specific hardware variations for each country. Similarly, a simplified system could be established where the ON state and CLASS-B states are synonymous so there are only two states, the OFF state and the CLASS-B state.

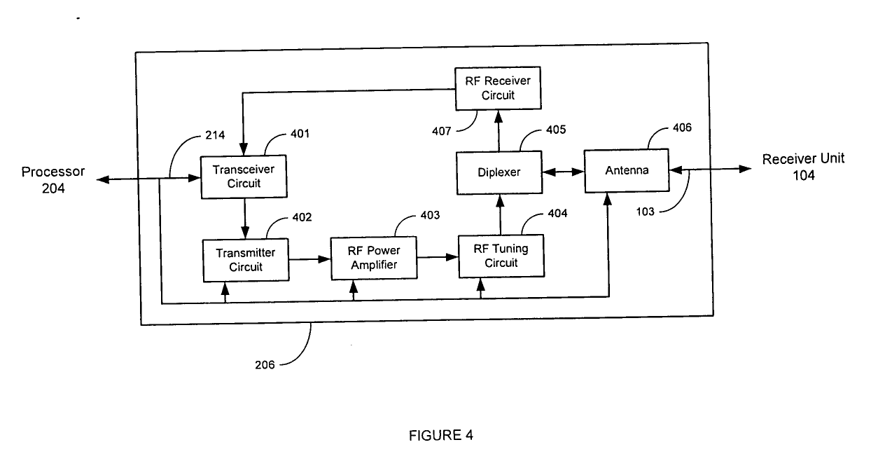

FIG. 4 is a block diagram of the RF transmitter/transceiver section of the transmitter unit shown in FIG. 2 in accordance with another embodiment of the present invention. More specifically, in one embodiment, the RF transmitter/transceiver section 206 may be configured as a bi-directional transmit and receive unit. Referring to the Figure, the RF transceiver 206 in one embodiment includes a transceiver circuit 401 configured to communicate with the processor 204 through the control and data link 214. The transmitter portion of the transceiver 206 includes a transmitter circuit 402, an RF power amplifier 403, RF tuning circuitry 404, a diplexer 405, and an antenna 406, the output of which is operatively coupled to the receiver unit 104 through the communication link 103. The receiver portion of the transceiver 206 includes an RF receiver circuit 407 which receives RF signals from the diplexer 405 and provides digital signals to the transceiver circuit 401.

For example, in one embodiment of the present invention, when transmitting in the ON State, the transceiver circuit 401 receives digital signals (data and control) from the processor 204 via the control and data link 214. Similarly, the transmitter circuit 402 receives digital signals (data and control) from the processor 204 via the transceiver circuit 401 and the data link 214, and in turn, generates an RF signal.

The RF power amplifier 403 has a high impedance input of 1000 Ohms or higher and low impedance output capable of driving heavy loads such as 20 Ohms. Thus, the RF power amplifier 403 conditions the RF signal, under digital or analog control from the processor 204 via the control and data link 214, to provide an RF signal with the proper power (i.e. 13 dBm) for a given signal strength, such as 50 Ohms, to allow RF transmission. The RF tuning circuit 404, also under digital or analog control from the processor 204 via the control and data link 214 as needed, may be configured to impedance match the RF signal to the antenna for optimal or desired RF transmission (i.e. a 13 dBm signal into the tuning circuit 404 may be a 12 dBm signal out of the tuning circuit 404).

The diplexer 405 may be configured to pass the RF signal from the tuning circuit 404 to the antenna 406 with a 3 dB loss (i.e. a 12 dBm signal into the diplexer 405 may be a 9 dBm signal out of the diplexer 405). Finally the antenna 406, again under digital or analog control from the processor 204 via the control and data link 214 as needed, may be configured to convert the RF signal from the RF tuning circuit 303 into a transmitted RF signal or an electromagnetic (EM) wave with the desired properties for RF transmission. For example a 9 dBm signal into antenna 406 with an efficiency of 67% will generate a 6 dBm EM wave.

Similarly, when receiving, a predetermined EM wave may generate an RF signal (for example a −34 dBm) out of the antenna 406. The diplexer 405 passes the RF signal from the antenna 406 with a 3 dB loss (i.e. a −34 dBm signal into the diplexer 405 may be a −37 dBm signal out of the diplexer 405). The RF signal from the diplexer 405 is converted to a digital signal by the RF receiver circuit 407 which is in turn received by the transceiver circuit 401. The processor 204 then reads (receives) the digital signals from the transceiver circuit 401 via the data link 214.

With the use of a transceiver, in accordance with the various embodiments of the present invention, a variety of communications schemes may be used to synchronize the transmitter unit 102 with the receiver unit 104 while saving power by not requiring each unit to be in a receive mode continuously. For example, after each RF transmission from the transmitter unit 102 to the receiver unit 104, or scheduled transmission for the OFF state, the transmitter unit 102 may enter a brief receive mode where the receiver unit 104 may or may not transmit an RF signal. This allows the receiver unit 104 to signal the transmitter unit 102 when the OFF state is active and the user applies the appropriate receive commands to change states.

In the manner described above, in accordance with one embodiment of the present invention, there is provided an RF transmitter with variable power output levels using, for example, a variable output RF power amplifier. More specifically, in one embodiment, the RF output power of the transmitter may be set to one of several predefined levels for normal operation and Class-B EMC compliant operation.

Moreover, as discussed above, the tuning circuitry associated with the antenna may be switched from a mode for tuning used for normal operation to one for Class-B EMC compliant operation. In turn, the RF output power of the transmitter may be configured to change with each of the antenna tuning circuitry configurations. In a further embodiment, the antenna configuration may be switched from a mode used for normal operation to one for Class-B EMC compliant operation. Again, the RF output power of the transmitter may be configured to change with each of the antenna configurations.

Additionally, in an alternate embodiment of the present invention, a combination of power amplifier output levels, antenna tuning circuitry configurations, and antenna configurations may be employed for normal operation and for Class-B EMC compliant operation. Moreover, the transmitter may be configured to transmit the signal wirelessly using proprietary transmission protocols, Bluetooth, Zigbee, and 802.11x transmission protocols.

Indeed, an apparatus for data transmission in one embodiment of the present invention includes an amplifier configured to receive a data signal, the amplifier further configured to amplify the received data signal, a tuning unit operatively coupled to the amplifier, the tuning unit configured to condition the amplified data signal, and an antenna operatively coupled to the tuning circuit, the antenna configured to transmit an output signal, where the output power of the output signal is configured to vary between a plurality of power output states.

The data signal may be associated with a measured glucose data.

The amplifier may include an RF power amplifier, and further, wherein the tuning circuit includes an RF tuning circuit, where the RF power amplifier may include a variable RF power amplifier, the RF tuning circuit may include a variable RF tuning circuit, and the antenna may include a variable antenna.

Further, the plurality of power output states may include a full power output state, a power down state, and an EMC Class-B compliant operating power output state, including RF frequency of one of approximately 315 MHz, 433 MHz and 2.4 GHz.

Moreover, the plurality of power output states may be configured to operate under one of a Bluetooth transmission protocol, a Zigbee transmission protocol, and an 802.11x transmission protocol.

Additionally, a diplexer may be operatively coupled to the antenna and configured to route data to and from the antenna.

A data monitoring system in a further embodiment of the present invention includes a sensor unit configured to detect one or more signals associated with a physiological condition, a transmitter unit configured to receive the one or more signals from the sensor unit, and a receiver unit configured to receive the one or more signals from the transmitter unit, where the output power of the one or more signals transmitted from the transmitter unit may be configured to vary between a plurality of power output states.

The sensor unit may in one embodiment include a subcutaneous glucose lo sensor, and further, the one or more signals may include blood glucose data.

Also, the transmitter unit may be configured to transmit the one or more signals received from the sensor unit under a wireless data transmission protocol.

The plurality of power output states discussed above may in one embodiment includes a full power output state, a power down state, and an EMC Class-B compliant operating power output state, and also, may be configured to operate under one of a Bluetooth transmission protocol, a Zigbee transmission protocol, and an 802.11x transmission protocol.

The receiver in one embodiment may include a blood glucose monitor configured to generate an output signal based on the received one or more signals from the transmitter unit.

Additionally, the sensor unit may be configured to detect a predetermined number of glucose levels over a predefined time period, and further, where the transmitter unit may be further configured to transmit the predetermined number of glucose levels substantially in real time relative to the corresponding detection by the sensor unit over the predefined time period.

The receiver unit in one embodiment may be configured to receive the predetermined number of glucose levels over the predefined time period from the transmitter unit, and further, to generate one or more signals corresponding to each of the predetermined number of glucose levels received from the transmitter unit.

Also, the receiver unit may be further configured to display the generated one or more signals substantially in real time relative to the reception of the corresponding glucose levels from the transmitter.

The system in a further embodiment may also include patient treatment unit, the patent treatment unit configured to receive the one or more generated signals from the receiver unit, where the patient treatment unit may further be configured to generate a treatment protocol for the physiological condition based on the one or more generated signals from the receiver unit.

Also, the patient treatment unit may include in one embodiment an insulin pump to provide insulin therapy to the patient.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. An apparatus for data transmission, comprising:
an amplifier configured to receive a data signal, the amplifier further configured to amplify the received data signal;
a tuning unit operatively coupled to the amplifier, the tuning unit configured to condition the amplified data signal; and
an antenna operatively coupled to the tuning circuit, the antenna configured to transmit an output signal;
wherein the output power of the output signal is configured to vary between a plurality of power output states.

2. The apparatus of claim 1, wherein the data signal is associated with a measured glucose data.

3. The apparatus of claim 1 wherein the amplifier includes an RF power amplifier, and further, wherein the tuning circuit includes an RF tuning circuit.

4. The apparatus of claim 3 wherein the RF power amplifier includes a variable RF power amplifier, the RF tuning circuit includes a variable RF tuning circuit, and the antenna includes a variable antenna.

5. The apparatus of claim 1 wherein the plurality of power output states includes a full power output state, a power down state, and an EMC Class-B compliant operating power output state.

6. The apparatus of claim 1 wherein the plurality of power output states includes RF frequency of one of approximately 315 MHz, 433 MHz and 2.4 GHz.

7. The apparatus of claim 1 wherein the plurality of power output states are configured to operate under one of a Bluetooth transmission protocol, a Zigbee transmission protocol, and an 802.11x transmission protocol.

8. The apparatus of claim 1 further including a diplexer operatively coupled to the antenna, the diplexer configured to route data to and from the antenna.

9. A data monitoring system, comprising:
a sensor unit configured to detect one or more signals associated with a physiological condition;
a transmitter unit configured to receive the one or more signals from the lo sensor unit; and
a receiver unit configured to receive the one or more signals from the transmitter unit;
wherein the output power of the one or more signals transmitted from the transmitter unit is configured to vary between a plurality of power output states.

10. The system of claim 9 wherein the sensor unit includes a subcutaneous glucose sensor, and further, wherein the one or more signals include blood glucose data.

11. The system of claim 9 wherein the transmitter unit is configured to transmit the one or more signals received from the sensor unit under a wireless data transmission protocol.

12. The system of claim 9 wherein the plurality of power output states includes a full power output state, a power down state, and an EMC Class-B compliant operating power output state.

13. The system of claim 9 wherein the plurality of power output states are configured to operate under one of a Bluetooth transmission protocol, a Zigbee transmission protocol, and an 802.11x transmission protocol.

14. The system of claim 9 wherein the receiver includes a blood glucose monitor configured to generate an output signal based on the received one or more signals from the transmitter unit.

15. The system of claim 9 wherein said sensor unit is configured to detect a predetermined number of glucose levels over a predefined time period, and further, wherein said transmitter unit is further configured to transmit said predetermined number of glucose levels substantially in real time relative to the corresponding lo detection by the sensor unit over the predefined time period.

16. The system of claim 15 wherein the receiver unit is configured to receive said predetermined number of glucose levels over said predefined time period from said transmitter unit, and further, to generate one or more signals corresponding to each of said predetermined number of glucose levels received from said transmitter unit.

17. The system of claim 16 wherein said receiver unit is further configured to display said generated one or more signals substantially in real time relative to the reception of the corresponding glucose levels from said transmitter.

18. The system of claim 16 further including a patient treatment unit, said patent treatment unit configured to receive the one or more generated signals from the receiver unit, the patient treatment unit further configured to generate a treatment protocol for the physiological condition based on the one or more generated signals from the receiver unit.

19. The system of claim 18 wherein said patient treatment unit includes an insulin pump.

20. A method of providing data transmission, comprising the steps of:
receiving a data signal and amplifying the received data signal;
conditioning the amplified data signal;
varying the output power of the output signal between a plurality of power output states; and
transmitting the output signal at the one of the plurality of power output states.
